(19) United States
(12) Patent Application Publication
(10) Pub. No.: US 2007/0159006 A1
(43) Pub. Date: Jul. 12, 2007

(54) Power supply apparatus and display apparatus having the same

(75) Inventors: Jin-hyung Lee, Anyang-si (KR); Young-deok Choi, Gimpo-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/637,130

(22) Filed: Dec. 12, 2006

(30) Foreign Application Priority Data
Jan. 12, 2006 (KR) 10-2006-0003499

(51) Int. Cl. H02J 3/00

(52) U.S. Cl. 307/17

(57) ABSTRACT

A power supply apparatus and display apparatus having the same are provided for outputting power, in which a standby mode selecting unit switches on and off a standby mode, a standby power supplying unit outputs standby power of a predetermined magnitude in the standby mode and temporarily outputs first auxiliary power when the standby mode is released by selecting of the standby mode selecting unit, a main power supplying unit outputs main power of a predetermined magnitude, and a backup power supplying unit continues to supply second auxiliary power, which is induced by the main power output from the main power supplying unit, to the main power supplying unit as driving power substituting the first auxiliary power. Thus, the output of standby power is increased when a standby mode is released, without increasing power consumption in the standby mode, using a standby power converter with small capacity.

### CROSS-REFERENCE TO RELATED APPLICATIONS

This application claims the benefit under 35 U.S.C. § 119(a) of Korean Patent Application No. 2006-0003499, filed on Jan. 12, 2006, in the Korean Intellectual Property Office, the entire disclosure of which is hereby incorporated by reference.

### BACKGROUND OF THE INVENTION

1. Field of the Invention

The present invention relates to a power supply apparatus and a display apparatus having the same. More particularly, the present invention relates to a power supply apparatus, which is capable of outputting standby power of a standby mode, and a display apparatus having the same.

2. Description of the Related Art

In general, electronic apparatuses in home and offices operate by using power from an AC adaptor or a battery. These electronic apparatuses consume a small quantity of standby power to maintain a standby mode under a condition where a plug of the AC adaptor is connected to the electronic apparatuses or the battery is mounted on the electronic apparatuses. The standby power used herein refers to power consumed when an electronic apparatus is in the standby mode. The electronic apparatuses consume the standby power to determine whether a power button or key is input to power the electronic apparatuses on, and, if the electronic apparatuses are powered on, release the standby mode and enter a normal mode by driving their circuit components (for example, a video signal processing unit, a scaler, a memory, and the like).

In this manner, since the electronic apparatuses continue to consume the standby power even under a condition where users do not use the electronic apparatuses, the electronic apparatuses employ power supply apparatuses to output a small quantity of standby power (typically less than 10 Watts) for the purpose of saving the standby power.

Hereinafter, a circuit diagram of a power supply apparatus of a conventional general electronic apparatus will be described with reference to FIG. 3. As shown in FIG. 3, a power supply apparatus includes a standby power converter 7, a main power converter 8, transformers T11, T13 and T14, diodes D, D13, D14 and D15, capacitors C and C12, and a switch S.

In a standby mode where the electronic apparatus is powered off, the standby power converter 7 switches a voltage Vin which is supplied from an AC adaptor or a battery and converted into a direct voltage with a predetermined period in order to change a magnitude of the voltage Vin. Then, the voltage Vin which is switched by the standby power converter 7 is applied to a primary side of the transformer T13 and accordingly induces an induction voltage as a standby power V_{standby} at a secondary side of the transformer T13. Then, the standby power V_{standby} of the secondary side of the transformer T13 induces an auxiliary power, which is stored in the capacitor C12, at a primary side of the transformer T14. In this case, the switch S is in an off state since the electronic apparatus is in the standby mode.

When a user pushes a power key to release the standby mode, that is, when the electronic apparatus is powered on, the switch S is switched on, and then, the auxiliary power induced at the primary side of the transformer T14 is input to the main power converter 8. The main power converter 8 is started by using the input auxiliary voltage as a driving power Vcc. In this case, since the switch S is in an on state, the auxiliary power continues to be induced at the primary side of the transformer T14 and continues to be input to the main power converter 8. Accordingly, the main power converter 8 continues to use the auxiliary power. Thus, the main power converter 8 using the auxiliary power as the driving power Vcc performs an operation of switching the voltage Vin with the predetermined period in order to output a main power Vₘₐᵢₙ through a secondary side of the transformer T11.

The standby power converter 7 of the power supply apparatus typically comprises a small output integrated circuit (IC) with small standby power, for example, output power of less than 10 Watts to save consumption of standby power. However, as described above, as the standby mode is released, when the output of the standby power converter 7 with the small output capacity is used for the standby power V_{standby} and power for driving the main power converter 8 and other circuit components (for example, the video processing unit, the scaler, the memory, and the like), the restriction on the output capacity (for example, 10 Watts) of the standby power converter 7 results in the restriction on the output of the standby power V_{standby}.

For example, in case of a conventional power supply apparatus employing the standby power converter 7 capable of outputting 10 Watts, if power of 5 Watts is used for power for driving the main power converter 8 and other circuit components (for example, the video signal processing unit, the scaler, the memory, and the like) as the standby mode is released, there is a problem in that the standby power V_{standby} is limited to 5 Watts.

Accordingly, there is a need for an improved power supply apparatus that increases output of standby power without increasing power consumption in a standby mode.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a power supply apparatus, which is capable of increasing output of standby power when a standby mode is released, without increasing power consumption in the standby mode, using a standby power converter with small capacity, and a display apparatus having the same.

The foregoing and/or other aspects of exemplary embodiments of the present invention are also achieved by providing a power supply apparatus for outputting power, in which a standby mode selecting unit switches on and off a standby mode, a standby power supplying unit outputs standby power of a predetermined magnitude in the standby mode and temporarily outputs first auxiliary power when the standby mode is released by selecting of the standby mode selecting unit, a main power supplying unit outputs main power of a predetermined magnitude, the main power supplying unit being driven by the first auxiliary power output from the standby power supplying unit, and a backup power supplying unit continues to supply second auxiliary power, which is induced by the main power output from the main power supplying unit, to the main power supplying unit as driving power substituting the first auxiliary power.

According to an aspect of exemplary embodiments of the present invention, the main power supplying unit comprises a main power converter for switching externally-input power according to a predetermined period in order to change a voltage magnitude of the externally-input power, the main power converter being driven by using at least one of the first auxiliary power and the second auxiliary power as driving power, and a first transformer having a primary side to which the externally-input power switched by the main power converter is applied and a secondary side to which power induced by the switched externally-input power applied to the primary side is output as the main power.

According to an aspect of exemplary embodiments of the present invention, the backup power supplying unit comprises a second transformer having a primary side at which the second auxiliary power is induced by the main power output from the secondary side of the first transformer, a first diode for controlling current of the second auxiliary power induced at the primary side of the second transformer to flow in one direction, a first capacitor for temporarily charging the induced second auxiliary power, and a second diode having an anode connected to a junction of a cathode of the first diode and an output terminal of the first capacitor through which the second auxiliary power is output, and a cathode connected to the main power supplying unit.

According to an aspect of exemplary embodiments the embodiment of the present invention, an output terminal through which the first auxiliary power is output from the standby power supplying unit is connected in series to the cathode of the second diode, and a branch line branching between the output terminal through which the first auxiliary, power is output from the standby power supplying unit and the cathode of the second diode is connected to the main power supplying unit.

According to an aspect of exemplary embodiments of the present invention, the second auxiliary power comprises a voltage larger than a voltage of the first auxiliary power.

According to an aspect of exemplary embodiments of the present invention, the standby power supplying unit comprises a standby power converter for switching externally-input power according to a predetermined period in order to change a voltage magnitude of the externally-input power, a third transformer having a primary side to which the externally-input power switched by the standby power converter is applied and a secondary side to which power induced by the switched externally-input power applied to the primary side of the third transformer is output as the standby power, and an auxiliary power supplying unit for outputting the first auxiliary power, which is induced by the standby power output through the secondary side of the third transformer, to the main power supplying unit when the standby mode is released.

According to an aspect of exemplary embodiments of the present invention, the auxiliary power supplying unit comprises a fourth transformer having a primary side at which the first auxiliary power is induced by the standby power output through the secondary side of the third transformer, a third diode for controlling current of the first auxiliary power induced at the primary side of the fourth transformer to flow in one direction, a second capacitor for charging the first auxiliary power generated in the standby mode and outputting the charged first auxiliary power when the standby mode is released, and a fourth diode having an anode connected to an output terminal of the second capacitor for outputting the first auxiliary power and a cathode connected to the main power supplying unit.

According to an aspect of exemplary embodiments of the present invention, the standby mode selecting unit comprises a switch provided between the second capacitor and the anode of the fourth diode for switching on/off the standby mode.

According to the embodiment of the present invention, the cathode of the second diode is connected in series to the cathode of the fourth diode, and a branch line branching between the cathode of the second diode and the cathode of the fourth diode is connected to the main power supplying unit.

According to an aspect of exemplary embodiments of the present invention, the second auxiliary power comprises a voltage larger than a voltage of the first auxiliary power.

The foregoing and/or other aspects of exemplary embodiments of the present invention are also achieved by providing a display apparatus including a display unit, comprising a processing unit processing an input video signal for displaying the input video signal on the display unit, a standby mode selecting unit for switching on/off the standby mode, and a power supply apparatus for outputting standby power of a predetermined magnitude to the processing unit in the standby mode, and outputting main power of a predetermined magnitude when the standby mode is released by selecting the standby mode selecting unit, wherein the power supply apparatus comprises a standby power supplying unit for outputting the standby power in the standby mode and temporarily further outputting first auxiliary power when the standby mode is released, a main power supplying unit for outputting the main power, the main power supplying unit being driven by the first auxiliary power output from the standby power supplying unit, and a backup power supplying unit for continuing to supply second auxiliary power, which is induced by the main power output from the main power supplying unit, to the main power supplying unit as driving power substituting the first auxiliary power.

According to an aspect of exemplary embodiments of the present invention, the main power supplying unit comprises a main power converter for switching externally-input power according to a predetermined period in order to change a voltage magnitude of the externally-input power, the main power converter being driven by using at least one of the first auxiliary power and the second auxiliary power as driving power, and a first transformer having a primary side to which the externally-input power switched by the main power converter is applied and a secondary side to which power induced by the switched externally-input power applied to the primary side is output as the main power.

According to an aspect of exemplary embodiments of the present invention, the backup power supplying unit comprises a second transformer having a primary side at which the second auxiliary power is induced by the main power output from the secondary side of the first transformer, a first diode for controlling current of the second auxiliary power induced at the primary side of the second transformer to flow in one direction, a first capacitor for temporarily charging the induced second auxiliary power, and a second diode having an anode connected to a junction of a cathode of the first diode and an output terminal of the first capacitor through which the second auxiliary power is output, and a cathode connected to the main power supplying unit.

According to an aspect of exemplary embodiments of the present invention, an output terminal through which the first auxiliary power is output from the standby power supplying unit is connected in series to the cathode of the second diode, and a branch line branching between the output terminal through which the first auxiliary power is output from the standby power supplying unit and the cathode of the second diode is connected to the main power supplying unit.

According to an aspect of exemplary embodiments of the present invention, the second auxiliary power comprises a voltage larger than a voltage of the first auxiliary power.

According to an aspect of exemplary embodiments of the present invention, the standby power supplying unit comprises a standby power converter for switching externally-input power according to a predetermined period in order to change a voltage magnitude of the externally-input power, a third transformer having a primary side to which the externally-input power switched by the standby power converter is applied and a secondary side to which power induced by the switched externally-input power applied to the primary side of the third transformer is output as the standby power, and an auxiliary power supplying unit for outputting the first auxiliary power, which is induced by the standby power output through the secondary side of the third transformer, to the main power supplying unit when the standby mode is released.

According to an aspect of exemplary embodiments of the present invention, the auxiliary power supplying unit comprises a fourth transformer having a primary side at which the first auxiliary power is induced by the standby power output through the secondary side of the third transformer, a third diode for controlling current of the first auxiliary power induced at the primary side of the fourth transformer to flow in one direction, a second capacitor for charging the first auxiliary power generated in the standby mode and outputting the charged first auxiliary power when the standby mode is released, and a fourth diode having an anode connected to an output terminal of the second capacitor for outputting the first auxiliary power and a cathode connected to the main power supplying unit.

According to an aspect of exemplary embodiments of the present invention, the standby mode selecting unit comprises a switch provided between the second capacitor and the anode of the fourth diode for switching on/off the standby mode.

According to an aspect of exemplary embodiments of the present invention, the cathode of the second diode is connected in series to the cathode of the fourth diode, and a branch line branching between the cathode of the second diode and the cathode of the fourth diode is connected to the main power supplying unit.

According to the embodiment of the present invention, the second auxiliary power comprises a voltage larger than a voltage of the first auxiliary power.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 is a schematic control block diagram of a display apparatus according to an exemplary embodiment of the present invention;

FIG. 2 is a detailed circuit diagram of a power supply apparatus according to an exemplary embodiment of the present invention; and

FIG. 3 is a detailed circuit diagram of a conventional power supply apparatus.

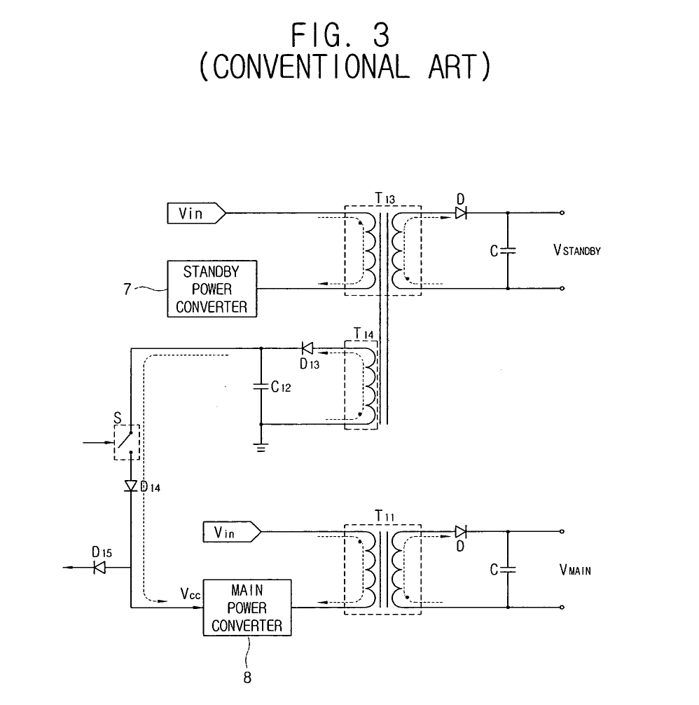

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

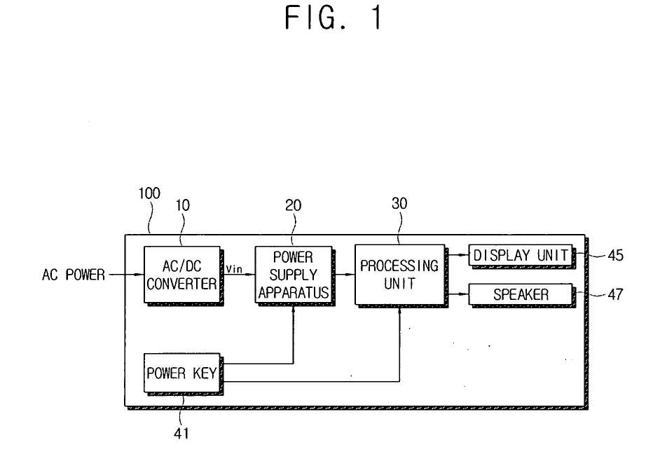

FIG. 1 is a schematic control block diagram of a display apparatus according to an exemplary embodiment of the present invention. Referring to FIG. 1, a display apparatus 100 includes an AC/DC converter 10, a power supply apparatus 20, a processing unit 30, a power key 41, a display unit 45, and a speaker 47.

The AC/DC converter 10 converts alternating power, which is supplied from at least one of a battery provided inside or outside the display apparatus 100 and an AC adaptor for receiving commercial power into a direct power.

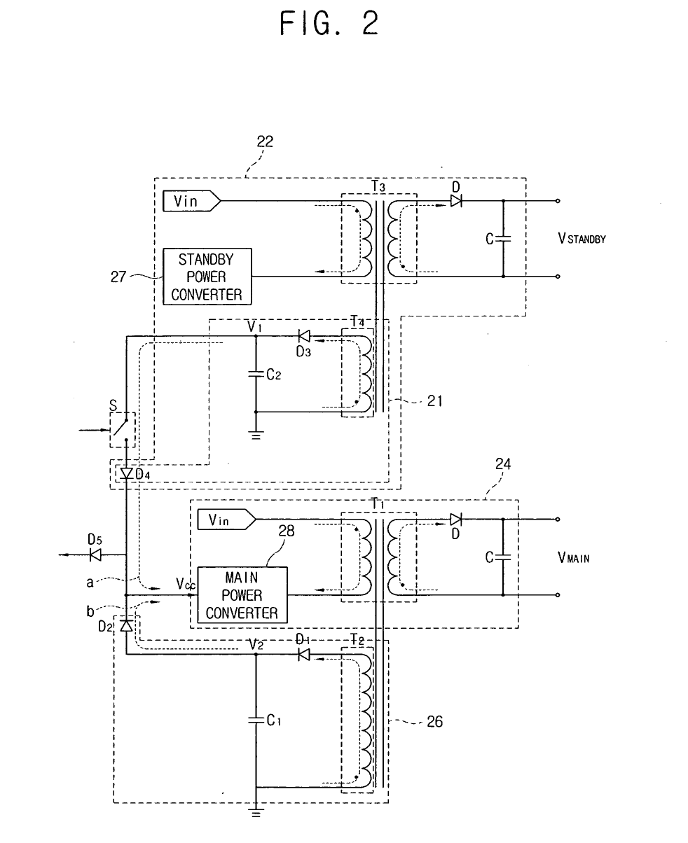

The power supply apparatus 20 converts power Vin output from the AC/DC converter 10 into power with a magnitude of voltage usable as a driving voltage by the processing unit 30 and other circuit parts (not shown). The power supply apparatus 20 is preferably but not necessary a DC/DC converter, detailed circuital configuration of which will be described later with reference to FIG. 2.

The processing unit 30 processes an input video signal to be displayed on the display unit 45. The processing unit 30 may include a scaler for scaling the input video signal to a format displayable on the display unit 45, a signal converter for converting the input video signal into a video signal, which can be processed by the scaler, other various circuit parts such as a memory, a light emitting diode (LED), and the like, and a microcomputer for detecting input from the power key 41 and controlling the above circuit units in the processing unit 30 to perform a general driving operation when a standby mode is released. In addition, the processing unit 30 may process a sound signal included in the input video signal or a separately input sound signal to be output through the speaker 47.

The power key 41 is provided as a key for selecting power-on/off of the display apparatus 100. For example, the power key 41 is a component included in a standby mode selecting unit for switching on or off the standby mode of the display apparatus 100. When the power key 41 is pushed in the standby mode, the standby mode is released. When the power key 41 is pushed in a state where the standby mode is released, the display apparatus enters the standby mode.

The display unit 45 displays an image by receiving the video signal from the processing unit 30. The display unit 45 includes a display panel on which the image is displayed, and a panel driving unit for processing the video signal input from the processing unit 30 such that the image is displayed on the display panel.

The speaker 47 receives the sound signal from the processing unit 30 and outputs the received sound signal as an audible sound.

Hereinafter, a circuit diagram of the power supply apparatus 20 of the present invention will be described with reference to FIG. 2.

Referring to FIG. 2, the power supply apparatus 20 includes a switch S included in the standby mode selecting unit for switching on/off the standby mode, a standby power supplying unit 22 for outputting standby power V_{standby} of a predetermined magnitude in the standby mode and further temporarily outputting first auxiliary power when the standby mode is released, a main power supplying unit 24, which is driven by the first auxiliary power output from the standby power supplying unit 22, for outputting main power Vₘₐᵢₙ of a predetermined magnitude, and a backup power supplying unit 26 for continuing to supply second auxiliary power, which is induced by the main power Vₘₐᵢₙ output from the main power supplying unit 24, as driving power substituting the first auxiliary power, to the main power supplying unit 24.

The standby power supplying unit 22 includes a standby power converter 27 for switching the power Vin according to a predetermined period in order to change a voltage magnitude of the power Vin output from the AC/DC converter 10 (shown in FIG. 1), a third transformer T3 having a primary side to which the power Vin switched by the standby power converter 27 is applied and a secondary side to which power induced by the power Vin applied to the primary side is output as the standby power V_{standby}, and an auxiliary power supplying unit 21 for outputting the first auxiliary power, which is induced by the standby power output through the secondary side of the third transformer T3, to the main power supplying unit 24 when the standby mode is released.

The auxiliary power supplying unit 21 includes a fourth transformer T4 having a primary side generating the first auxiliary power which is induced by the standby power V_{standby} output through the secondary side of the third transformer T3, a third diode D3 for controlling current of the first auxiliary power induced at the primary side of the fourth transformer T4 to flow in one direction, a second capacitor C2 for charging the first auxiliary power generated in the standby mode and outputting the charged first auxiliary power when the standby mode is released, and a fourth diode D4 having an anode connected to an output terminal of the second capacitor D2 for outputting the first auxiliary power and a cathode connected to the main power supplying unit 24.

The switch S, which is included in the standby mode selecting unit for switching on/off the standby mode, is on when the power key 41 is pushed, that is, when the power supply apparatus 20 is powered on. The switch S is off when the power key 41 is pushed once more, that is, when the power supply apparatus 20 is powered off. In other words, the standby mode selecting unit for switching on/off the standby mode includes the power key 41 and the switch S. The switch S is provided between the second capacitor C2 of the auxiliary power supplying unit 21 and the anode of the fourth diode D4 and controls connection/disconnection of a path along which the first auxiliary power induced at the primary side of the fourth transformer T4 is applied to the anode of the fourth diode D4.

While the first auxiliary power induced at the primary side of the fourth transformer T4 is charged in the second capacitor C2 in the standby mode, when the switch S is on as the standby mode is released, the first auxiliary power is applied through the fourth diode D4 to a main power converter 28 of the main power supplying unit 24, which will be described later.

The main power supplying unit 24 includes the main power converter 28 for switching the power Vin according to a predetermined period in order to change a voltage magnitude of the power Vin output from the AC/DC converter 10 (shown in FIG. 1), and a first transformer T1 having a primary side to which the power Vin switched by the main power converter 28 is applied and a secondary side to which power induced by the power Vin applied to the primary side is output as the main power Vₘₐᵢₙ.

The main power converter 28 is driven by driving power Vcc, which is at least one of the first auxiliary power applied from the auxiliary power supplying unit 21 of the standby power supplying unit 22 and the second auxiliary power applied from the backup power supplying unit 26. For example, the main power converter 28 is started by using the first auxiliary power applied from the auxiliary power supplying unit 21 as the driving power Vcc at an initial stage when the standby mode is released, and is driven by using the second auxiliary power applied from the backup power supplying unit 26 as the driving power Vcc in a normal state where a driving state is maintained.

The backup power supplying unit 26 includes a second transformer T2 having a primary side generating the second auxiliary power which is induced by the main power Vₘₐᵢₙ output from the secondary side of the first transformer T1, a first diode D1 for switching current of the second auxiliary power induced at the primary side of the second transformer T2 to flow in one direction, a first capacitor C1 for temporarily charging the second auxiliary power induced at the primary side of the second transformer T2, and a second diode D2 having an anode connected to a junction of a cathode of the first diode D1 and an output terminal of the first capacitor C1, and a cathode connected to the main power supplying unit 24.

As shown in FIG. 2, an output terminal, that is, the cathode of the fourth diode D4, through which the first auxiliary power is output from the auxiliary power supplying unit 21 of the standby power supplying unit 22, is connected in series to an output terminal, that is, the cathode of the second diode D2, through which the second auxiliary power is output from the backup power supplying unit 26 to confront each other. In addition, a branch line branching between the cathode of the second diode D2 and the cathode of the fourth diode D4 is connected to the main power converter 28 of the main power supplying unit 24.

In an exemplary implementation, a voltage V2 of the second auxiliary power output from the backup power supplying unit 26 is preferably but not necessary larger than a voltage V1 of the first auxiliary power output from the auxiliary power supplying unit 21. This may be implemented by various ways such as increasing the number of primary windings of the second transformer T2 over the number of primary windings of the fourth transformer T4.

Operation of the power supply apparatus 20 of the present invention when the standby mode is released, that is, when the power supply apparatus 20 is changed from the standby mode to the normal mode, will be described below.

In the standby mode where the power supply apparatus 20 is powered off, the standby power converter 27 switches the power Vin according to the predetermined period in order to change the voltage magnitude of the power Vin output from the AC/DC converter 10. Then, the power Vin switched by the standby power converter 27 is applied to the primary side of the third transformer T3, and power induced by the power Vin applied to the primary side of the third transformer T3 is output as the standby power V_{standby} through the secondary side of the third transformer T3. Then, the first auxiliary power is induced at the primary side of the fourth transformer T4 by the standby power V_{standby} output through the secondary side of the third transformer T3, and then is stored in the capacitor C2. The switch S is in an off state since the power supply apparatus 20 is in the standby mode.

While the first auxiliary power induced at the primary side of the fourth transformer T4 is charged in the second capacitor C2 in the standby mode, if a user pushes the power key to release the standby mode, the switch S is on. Accordingly, the first auxiliary power “a” is applied to the main power converter 28 of the main power supplying unit 24 through the fourth diode D4.

The main power converter 28 is then started by using the input first auxiliary power “a” as the driving power Vcc. The main power converter 28 started by using the first auxiliary power “a” initiates operation of switching the power Vin according to a predetermined period in order to change a voltage magnitude of the power Vin output from the AC/DC converter 10. Then, the power Vin switched by the main power converter 28 is applied to the primary side of the first transformer T1. Power induced by the power Vin applied to the primary side of the first transformer T1 is output as the main power Vₘₐᵢₙ through the secondary side of the first transformer T1. Then, circuit components in the processing unit 30 are driven to perform their respective functions by using the main power Vₘₐᵢₙ output from the power supply apparatus 20 as the driving power.

The second auxiliary power “b” is then induced at the primary side of the second transformer T2 by the main power Vₘₐᵢₙ output through the secondary side of the first transformer T1. In this case, at an initial stage when the second auxiliary power is induced at the primary side of the second transformer T2, since the voltage V1 of the first auxiliary power “a” applied to the main power converter 28 is larger than the voltage V2 of the second auxiliary power “b”, the second auxiliary power is temporarily charged in the first capacitor C1. The fourth diode D4 then becomes nonconductive when the voltage V2 of the induced second auxiliary power “b” becomes larger than the voltage V1 of the first auxiliary power “a”. The second auxiliary power “b” output from the backup power supplying unit 21 is then applied to the main power converter 28 of the main power supplying unit 24. Here, the second auxiliary power “b” output from the backup power supplying unit 21 may be supplied to circuit components in the processing unit 30 through a fifth diode D5. In this manner, since the voltage V1 of the first auxiliary power “a” is larger than the voltage V2 of the second auxiliary power “b”, time taken for the second auxiliary power “b” to be temporarily charged in the first capacitor C1 will be very short.

For example, since the second auxiliary power “b” with the voltage V2 larger than the voltage V1 of the first auxiliary power “a” output from the auxiliary power supplying unit 21 is output from the backup power supplying unit 26, the auxiliary power supplying unit 21 does not generate/output the first auxiliary power “a”. Accordingly, there is no need to consume power to generate the first auxiliary power “a” in the standby power supplying unit 22 in the normal mode. Accordingly, when the standby mode is released, that is, when the display apparatus enters the normal mode, the power supply apparatus and the display apparatus including the same according to an exemplary embodiment of the present invention may use output of the standby power converter 27 with small capacity as the standby power V_{standby}. For example, if the power supply apparatus 20 employs the standby power converter 27 with output capacity of 10 Watts when the standby mode is released, the first auxiliary power “a” (for example, 5 Watts) is temporarily supplied to the main power converter 8 and circuit components (for example, a signal converting unit, a scaler, a memory, an LED, and the like) in the processing unit 30. While the standby power V_{standby} of 5 Watts is supplied, the output (10 Watts) of the standby power converter 27 is used as the standby power V_{standby} when the second auxiliary power “b” is generated.

As described above, the power supply apparatus and the display apparatus including the same according to an exemplary embodiment of the present invention may supply the driving power of the main power converter 28 using the second auxiliary power from the backup power supplying unit 26 when the standby mode is released, without increase of production costs by use of a standby power converter with large capacity or by additional use of a separate power converter. According to the present invention, since the standby power converter with small capacity can be still used and the output (for example, 10 Watt) of the standby power converter 27 is used as the standby power V_{standby} when the standby mode is released, the standby power can be increased when the standby mode is released without increase of the standby power consumption in the standby mode.

As apparent from the above description, the present invention provides a power supply apparatus, which is capable of increasing output of standby power when a standby mode is released, without increasing power consumption in the standby mode, using a standby power converter with small capacity, and a display apparatus having the same.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A power supply apparatus for outputting power, the apparatus comprising:
a standby mode selecting unit for switching on and off a standby mode;
a standby power supplying unit for outputting standby power of a predetermined magnitude in the standby mode and temporarily outputting first auxiliary power when the standby mode is released by selecting of the standby mode selecting unit;
a main power supplying unit for outputting main power of a predetermined magnitude, the main power supplying unit being driven by the first auxiliary power output from the standby power supplying unit; and
a backup power supplying unit for continuing to supply second auxiliary power, which is induced by the main power output from the main power supplying unit, to the main power supplying unit as driving power substituted for the first auxiliary power.

2. The power supply apparatus according to claim 1, wherein the main power supplying unit comprises:
a main power converter for switching externally-input power according to a reference period in order to change a voltage magnitude of the externally-input power, the main power converter being driven by using at least one of the first auxiliary power and the second auxiliary power as driving power; and
a first transformer comprising a primary side to which the externally-input power switched by the main power converter is applied and a secondary side to which power induced by the switched externally-input power applied to the primary side is output as the main power.

3. The power supply apparatus according to claim 2, wherein the backup power supplying unit comprises:
a second transformer having a primary side at which the second auxiliary power is induced by the main power output from the secondary side of the first transformer;
a first diode for controlling current of the second auxiliary power induced at the primary side of the second transformer to flow in one direction;
a first capacitor for temporarily charging the induced second auxiliary power; and
a second diode comprising an anode connected to a junction of a cathode of the first diode and an output terminal of the first capacitor through which the second auxiliary power is output, and a cathode connected to the main power supplying unit.

4. The power supply apparatus according to claim 3, further comprising an output terminal through which the first auxiliary power is output from the standby power supplying unit is connected in series to the cathode of the second diode, and a branch line branching between the output terminal through which the first auxiliary power is output from the standby power supplying unit and the cathode of the second diode is connected to the main power supplying unit.

5. The power supply apparatus according to claim 4, wherein the second auxiliary power comprises a voltage larger than a voltage of the first auxiliary power.

6. The power supply apparatus according to claim 1, wherein the standby power supplying unit comprises:
a standby power converter for switching externally-input power according to a reference period in order to change a voltage magnitude of the externally-input power;
a third transformer comprising a primary side to which the externally-input power switched by the standby power converter is applied and a secondary side to which power induced by the switched externally-input power applied to the primary side of the third transformer is output as the standby power; and
an auxiliary power supplying unit for outputting the first auxiliary power, which is induced by the standby power output through the secondary side of the third transformer, to the main power supplying unit when the standby mode is released.

7. The power supply apparatus according to claim 6, wherein the auxiliary power supplying unit comprises:
a fourth transformer comprising a primary side at which the first auxiliary power is induced by the standby power output through the secondary side of the third transformer;
a third diode for controlling current of the first auxiliary power induced at the primary side of the fourth transformer to flow in one direction;
a second capacitor for charging the first auxiliary power generated in the standby mode and outputting the charged first auxiliary power when the standby mode is released; and
a fourth diode comprising an anode connected to an output terminal of the second capacitor for outputting the first auxiliary power and a cathode connected to the main power supplying unit.

8. The power supply apparatus according to claim 7, wherein the standby mode selecting unit comprises a switch provided between the second capacitor and the anode of the fourth diode for switching on and off the standby mode.

9. The power supply apparatus according to claim 8, wherein the cathode of the second diode is connected in series to the cathode of the fourth diode, and a branch line branching between the cathode of the second diode and the cathode of the fourth diode is connected to the main power supplying unit.

10. The power supply apparatus according to claim 9, wherein the second auxiliary power comprises a voltage larger than a voltage of the first auxiliary power.

11. A display apparatus comprising a display unit, comprising:
a processing unit processing an input video signal for displaying the input video signal on the display unit;
a standby mode selecting unit for switching on and off the standby mode; and
a power supply apparatus for outputting standby power of a magnitude to the processing unit in the standby mode, and outputting main power of a magnitude when the standby mode is released by selecting the standby mode selecting unit,
wherein the power supply apparatus comprises a standby power supplying unit for outputting the standby power in the standby mode and temporarily outputting first auxiliary power when the standby mode is released, a main power supplying unit for outputting the main power, the main power supplying unit being driven by the first auxiliary power output from the standby power supplying unit, and a backup power supplying unit for continuing to supply second auxiliary power, which is induced by the main power output from the main power supplying unit, to the main power supplying unit as driving power substituting the first auxiliary power.

12. The display apparatus according to claim 11, wherein the main power supplying unit comprises:
a main power converter for switching externally-input power according to a reference period in order to change a voltage magnitude of the externally-input power, the main power converter being driven by using at least one of the first auxiliary power and the second auxiliary power as driving power; and
a first transformer comprising a primary side to which the externally-input power switched by the main power converter is applied and a secondary side to which power induced by the switched externally-input power applied to the primary side is output as the main power.

13. The display apparatus according to claim 12, wherein the backup power supplying unit comprises:
a second transformer comprising a primary side at which the second auxiliary power is induced by the main power output from the secondary side of the first transformer;
a first diode for controlling current of the second auxiliary power induced at the primary side of the second transformer to flow in one direction;
a first capacitor for temporarily charging the induced second auxiliary power; and
a second diode comprising an anode connected to a junction of a cathode of the first diode and an output terminal of the first capacitor through which the second auxiliary power is output, and a cathode connected to the main power supplying unit.

14. The display apparatus according to claim 13, further comprising an output terminal through which the first auxiliary power is output from the standby power supplying unit is connected in series to the cathode of the second diode, and a branch line branching between the output terminal through which the first auxiliary power is output from the standby power supplying unit and the cathode of the second diode is connected to the main power supplying unit.

15. The display apparatus according to claim 14, wherein the second auxiliary power comprises a voltage larger than a voltage of the first auxiliary power.

16. The display apparatus according to claim 11, wherein the standby power supplying unit comprises:
a standby power converter for switching externally-input power according to a reference period in order to change a voltage magnitude of the externally-input power;
a third transformer comprising a primary side to which the externally-input power switched by the standby power converter is applied and a secondary side to which power induced by the switched externally-input power applied to the primary side of the third transformer is output as the standby power; and
an auxiliary power supplying unit for outputting the first auxiliary power, which is induced by the standby power output through the secondary side of the third transformer, to the main power supplying unit when the standby mode is released.

17. The display apparatus according to claim 16, wherein the auxiliary power supplying unit comprises:
a fourth transformer comprising a primary side at which the first auxiliary power is induced by the standby power output through the secondary side of the third transformer;
a third diode for controlling current of the first auxiliary power induced at the primary side of the fourth transformer to flow in one direction;
a second capacitor for charging the first auxiliary power generated in the standby mode and outputting the charged first auxiliary power when the standby mode is released; and
a fourth diode comprising an anode connected to an output terminal of the second capacitor for outputting the first auxiliary power and a cathode connected to the main power supplying unit.

18. The display apparatus according to claim 17, wherein the standby mode selecting unit comprises a switch provided between the second capacitor and the anode of the fourth diode for switching on and off the standby mode.

19. The display apparatus according to claim 18, wherein the cathode of the second diode is connected in series to the cathode of the fourth diode, and a branch line branching between the cathode of the second diode and the cathode of the fourth diode is connected to the main power supplying unit.

20. The display apparatus according to claim 19, wherein the second auxiliary power comprises a voltage larger than a voltage of the first auxiliary power.

21. A display apparatus comprising:
a display unit for displaying an input video signal processed by a processing unit;
a standby mode selecting unit for switching on and off the standby mode; and
a power supply apparatus for outputting standby power of a magnitude to the processing unit in the standby mode, and outputting main power of a magnitude when the standby mode is released by selecting the standby mode selecting unit.

22. The display apparatus of claim 21, wherein the power supply apparatus comprises:
a standby power supplying unit for outputting the standby power in the standby mode and temporarily outputting first auxiliary power when the standby mode is released, a main power supplying unit for outputting the main power, the main power supplying unit being driven by the first auxiliary power output from the standby power supplying unit; and
a backup power supplying unit for continuing to supply second auxiliary power, which is induced by the main power output from the main power supplying unit, to the main power supplying unit as driving power substituting the first auxiliary power.

23. The display apparatus according to claim 21, wherein the main power supplying unit comprises:
a main power converter for switching externally-input power according to a reference period in order to change a voltage magnitude of the externally-input power, the main power converter being driven by using at least one of the first auxiliary power and the second auxiliary power as driving power; and
a first transformer comprising a primary side to which the externally-input power switched by the main power converter is applied and a secondary side to which power induced by the switched externally-input power applied to the primary side is output as the main power.

24. The display apparatus according to claim 23, wherein the backup power supplying unit comprises:
a second transformer comprising a primary side at which the second auxiliary power is induced by the main power output from the secondary side of the first transformer;
a first diode for controlling current of the second auxiliary power induced at the primary side of the second transformer to flow in one direction;
a first capacitor for temporarily charging the induced second auxiliary power; and
a second diode comprising an anode connected to a junction of a cathode of the first diode and an output terminal of the first capacitor through which the second auxiliary power is output, and a cathode connected to the main power supplying unit.

25. The display apparatus according to claim 24, further comprising an output terminal through which the first auxiliary power is output from the standby power supplying unit is connected in series to the cathode of the second diode, and a branch line branching between the output terminal through which the first auxiliary power is output from the standby power supplying unit and the cathode of the second diode is connected to the main power supplying unit.

26. The display apparatus according to claim 25, wherein the second auxiliary power comprises a voltage larger than a voltage of the first auxiliary power.

27. The display apparatus according to claim 21, wherein the standby power supplying unit comprises:
a standby power converter for switching externally-input power according to a reference period in order to change a voltage magnitude of the externally-input power;
a third transformer comprising a primary side to which the externally-input power switched by the standby power converter is applied and a secondary side to which power induced by the switched externally-input power applied to the primary side of the third transformer is output as the standby power; and
an auxiliary power supplying unit for outputting the first auxiliary power, which is induced by the standby power output through the secondary side of the third transformer, to the main power supplying unit when the standby mode is released.

28. The display apparatus according to claim 27, wherein the auxiliary power supplying unit comprises:
a fourth transformer comprising a primary side at which the first auxiliary power is induced by the standby power output through the secondary side of the third transformer;
a third diode for controlling current of the first auxiliary power induced at the primary side of the fourth transformer to flow in one direction;
a second capacitor for charging the first auxiliary power generated in the standby mode and outputting the charged first auxiliary power when the standby mode is released; and
a fourth diode comprising an anode connected to an output terminal of the second capacitor for outputting the first auxiliary power and a cathode connected to the main power supplying unit.

29. The display apparatus according to claim 28, wherein the standby mode selecting unit comprises a switch provided between the second capacitor and the anode of the fourth diode for switching on and off the standby mode.

30. The display apparatus according to claim 29, wherein the cathode of the second diode is connected in series to the cathode of the fourth diode, and a branch line branching between the cathode of the second diode and the cathode of the fourth diode is connected to the main power supplying unit.

31. The display apparatus according to claim 30, wherein the second auxiliary power comprises a voltage larger than a voltage of the first auxiliary power.
